(19) United States
(12) Patent Application Publication
(10) Pub. No.: US 2017/0077542 A1
(43) Pub. Date: Mar. 16, 2017

(54) Fuel Cell Housing

(71) Applicant: Bayerische Motoren Werke Aktiengesellschaft, Muenchen (DE)

(72) Inventors: Johannes SCHMID, Muenchen (DE); Lukas WITTCHEN, Muenchen (DE); Andreas BUCHNER, Steinebach (DE); Maximilian ZETTL, Weehawken, NJ (US)

(21) Appl. No.: 15/361,137

(22) Filed: Nov. 25, 2016

Related U.S. Application Data
(63) Continuation of application No. PCT/EP2015/059163, filed on Apr. 28, 2015.

(30) Foreign Application Priority Data
May 28, 2014 (DE) 10 2014 210 262.6

(51) Int. Cl. H01M 8/2475; B32B 7/02; B32B 5/26; H01M 8/2485; B32B 5/02

(52) U.S. Cl. CPC H01M 8/2475; H01M 8/2485; B32B 5/028; B32B 5/26; B32B 7/02; B32B 2307/202; B32B 2307/542; B32B 2307/206; B32B 2262/103; B32B 2262/106; B32B 2262/0269; B32B 2262/101; B32B 2457/18; B32B 2260/021; B32B 2260/046

(57) ABSTRACT

A fuel cell housing has at least one portion that has at least three layers, including a first, outward-facing layer designed as an electrically conductive layer, a second layer for absorbing mechanical forces and as a penetration shield, and a third layer designed as a high voltage-insulating, hydrogen-insulating layer.

### CROSS REFERENCE TO RELATED APPLICATIONS

This application is a continuation of PCT International Application No. PCT/EP2015/059163, filed Apr. 28, 2015, which claims priority under 35 U.S.C. §119 from German Patent Application No. 10 2014 210 262.6, filed May 28, 2014, the entire disclosures of which are herein expressly incorporated by reference.

### BACKGROUND AND SUMMARY OF THE INVENTION

The present invention relates to a highly functional fuel cell housing which is improved in terms of installation space and reduced in weight.

A fuel cell housing in a fuel-cell system serves for housing fuel cells which are assembled to form a stack. By virtue of safety-relevant aspects, the housing must be developed such that the latter prevents leaking of reaction gases and, even in the case of mechanical stress such as in the case of an impact or shock, does not suffer any fissure formation or other destruction which compromises the functionality or the safety of the fuel-cell system. As is described for example in DE 1 496 110, the fuel cell housing is therefore in most instances formed from metal. A construction mode using ceramics, thus additionally having an electrically isolating effect, is also possible, such that a separate layer for electrical isolation, which in the case of metallic housings is achieved by providing a large air gap between the fuel cells and the housing, may be eliminated. The high weight and an inefficient construction mode in terms of installation space are disadvantageous in conventional fuel cell housings.

Proceeding from this prior art, it is therefore an object of the present invention to provide a fuel cell housing which is distinguished by high functionality at reduced dead weight and by a construction mode which is optimized in terms of installation space.

This and other objects are achieved in the case of a fuel cell housing according to the invention in that the fuel cell housing comprises at least one portion which is constructed from multiple layers and has at least three layers. Such a portion may be considered to be a lateral face or a base face, for example, which has the specific multi-layered construction according to the invention. However, a plurality of faces of the fuel cell housing, or else the entire fuel cell housing, may be characterized by the multi-layered construction according to the invention. In any case, the at least one portion has a layered construction which comprises at least three layers, specifically a first outwardly facing layer, a second layer, and a third layer, wherein the second layer and the third layer in terms of the arrangement thereof in relation to the first layer may vary. The layers fulfil dissimilar functions, and may each be configured as a single layer or as a multi-layered arrangement per se.

The first layer, that is to say the outermost layer of the fuel cell housing, which is in contact with the environment of the fuel cell housing, is configured as an electrically conductive layer, serving for grounding the fuel cell and as an electromagnetic compatibility shield, or as a detection potential in the case of faulty isolation, respectively. An intervention into the interior of the fuel cell housing is prevented on account thereof, and faults may be detected. The second layer serves for receiving mechanical forces, for example by way of deformation, and as a penetration protection. The incursion of items or of other components by way of manipulation or in the event of a crash, and the formation of a leak, are prevented by providing the penetration protection. The fuel cells thus remain untouched in terms of shape, arrangement, and function, and the safety of the system is guaranteed. The third layer is configured as a layer which insulates against high-voltage and hydrogen. The requirements set for electrical safety, in particular in terms of resistance to a disruptive discharge and as a creep path, are guaranteed to the largest extent by the third layer. Moreover, the individual fuel cells are isolated in relation to one another, and isolation in relation to the housing is also achieved such that isolating air gaps may be dispensed with in favor of as small a volume of the fuel cell housing as possible. The operational safety of the fuel cells is increased by the additional function of the third layer, which insulates against hydrogen. The provision of both functionalities in the third layer may readily be performed by dissimilar, in particular polymer, coatings.

By virtue of the multi-layered layered construction of at least one portion of the fuel cell housing according to the invention, as has been presented above, the required and very complex functionality of the housing is distributed across a plurality of individual layers such that individual adaptation of the layers in terms of shape and function is performed while considering a construction mode which is as space saving as possible and thus a reduced spatial volume at as low a weight as possible. The combination of functional layers having dissimilar structures thus also combines the advantageous properties of the respective individual layers while utilizing complementary synergies. The requirements set for protection against contact, such as have to be met according to ISO 20654, for example, are thus fulfilled in a very positive manner. The multi-layered structure likewise fulfills the preconditions which are set for a housing having a high-voltage insulating layer, specifically that of a protection against a disruptive discharge of 2500 V, for example, and thus in particular also that of a sufficient creep path (see DIN 60644), an air clearance (see DIN 60664), and a conductivity of approx. 50 MΩ. The fuel cell housing, not least by virtue of the first layer thereof which acts as a grounding, thus offers high protection against contact, protection in the case of a fault, and thus a high level of safety in terms of application, but by the hydrogen-insulating function and the mechanical stability of the second and of the third layers in general also is distinguished by a high level of operational reliability in the event of a crash.

For further reducing weight while simultaneously providing properties which offer good electrical isolation, the first layer comprises meshes, fibers and/or films/foils from conductive materials, such as aluminum or steel, for example, or from conductive polymers. By virtue of the very high stability in relation to the corrosion, the use of a copper mesh is particularly preferable.

Since connectors or interfaces which enable electrical or another linking of the fuel cell housing or of the components contained therein, respectively, should be provided on a housing, it is furthermore advantageously provided with a view toward further weight reduction and a saving in terms of installation space that the first layer and/or the second layer comprise(s) connectors and/or screw connections for fastening the fuel cell housing, or for fastening further components, respectively, or for conducting media. This is particularly readily implementable by virtue of the electrical conductivity of the first layer. Connectors and the like herein may be already considered in the production process of the fuel cell housing, for example, by providing conduits or media conductors which are sealed by means of injection-molding technology, for example, and which are integrated directly in the first layer of the housing. An external manifold may be mirrored by the housing per se by way of the media tightness. Thus, at least part of the housing according to the invention assumes an additional function of infeeding or discharging media, respectively, thus increasing the general level of functionality of the housing, while further saving weight for separate components. Furthermore advantageously, simple contacting by way of screw connections, for example, may be established on account thereof that the electrically conductive first layer is present on the external side of the housing. Sockets may also be integrated in the first layer or be connected to the first layer. On account thereof, the fuel cell housing according to the invention is installable in a simple and stable manner.

In order to provide even better stability in relation to any mechanical influence, and in particular in relation to bracing forces that act when bracing the fuel cell stack in relation to the housing, for example, operational stress or crash-related stress, and also in order for tertiary explosion-proofing, the second layer is formed from at least two individual layers. Specifically, the second layer is formed from a reinforcement layer for receiving mechanical loads, and a penetration-protection layer for providing protection against penetration. In order for both functions to be reflected in one layer, the second layer would have to be configured in a very solid manner, for example from a sheet-metal panel, on account of which a high weight will be introduced into the fuel cell system. This may be prevented by splitting the second layer into two individual layers having dissimilar functional focuses.

By virtue of the very good mechanical stability at a very low dead weight, the reinforcement layer is preferably formed from a fiber-composite material. According to the invention, the fiber-composite material comprises at least one fibrous material and at least one matrix material, wherein mixtures of dissimilar fibrous materials as well as of matrix materials may also be applied. The fibrous material herein preferably is available as a semi-finished textile product, that is to say in particular as a woven fabric, a cross-laid structure, a knitted fabric, a warp-knitted fabric, a braided fabric, and the like. The use of a fiber-composite material furthermore has the advantage that, owing to the manufacturing process of the fiber-composite material, the first layer may partially be integrated in the matrix material of the fiber-composite material. For example, if a copper mesh is used in the first layer, the matrix material of the reinforcement layer may flow around said copper mesh and, following curing, may bond said copper mesh in a stable manner. The use of carbon-fiber material in the fiber-composite material has proven particularly advantageous in terms of high stability at minimized dead weight.

By virtue of the outstanding resistance in relation to fissure formation in the event of any interaction with foreign items, the penetration-protection layer is preferably formed from Kevlar or metal. By virtue of the dead weight which, in comparison with metal, is reduced by a multiple, Kevlar is particularly well suited to being used in the manufacture of the penetration-protection layer.

In order for the installation space of the fuel cell housing to be further reduced, the third layer is formed from at least two individual layers, a high-voltage insulation layer and a hydrogen-insulation layer. The provision of a high-voltage insulation layer enables the fuel cell housing to be disposed directly about the fuel cell stack without providing an intermediate space, as is usual in the prior art, which is insulated by air which prevents an electrical incursion from the fuel cells to the housing. Since hydrogen is a small molecule which penetrates many materials without impediment, the separate provision of a hydrogen-insulation layer is advantageous from the point of view of a maximum retention capacity for hydrogen at a minimal introduction of weight.

For reasons of weight reduction, the high-voltage insulation layer preferably contains non-conducting polymers and/or glass fibers.

The hydrogen-insulation layer advantageously comprises a metal layer and/or a polymer layer. The polymer layer herein may be composed exclusively from one or a plurality of polymers, or may furthermore contain a fiber-containing material. These materials are distinguished by a high level of tightness in relation to hydrogen. For reasons of weight as well as for reasons of cost, a polymer layer is preferable to a metal layer. By contrast, metal layers for insulating against hydrogen may be manufactured in a simple manner by galvanic coating.

The further inboard the hydrogen-insulation layer is inside the housing structure, the fewer the layers that need to be protected against the influence of hydrogen, and presently in particular in relation to embrittlement. The hydrogen-insulation layer is thus preferably an innermost layer or a next-to innermost layer.

Alternatively, the high-voltage insulation layer is preferably a layer which faces the interior of the housing, since a required spacing of the electrical components to the housing may be further reduced on account thereof. Moreover, connectors and/or screw connections for fastening the components of the fuel cell housing, or for fastening further components, respectively, or for conduction media, may be provided very easily. The high-voltage insulation layer is preferably formed from a glass-fiber layer and/or from a polymer layer.

By way of the advantageous refinement of the second layer containing conductive materials, in particular conductive polymers, carbon fibers, carbon nanotubes, metal fibers, and mixtures thereof, the second layer may support discharging of electricity by the first layer specifically in the case of nonoperational currents.

In order for the operational safety of the fuel cell housing to be enhanced, the latter advantageously comprises at least one further layer which absorbs hydrogen or converts hydrogen. This further layer may bond hydrogen either physically or chemically, or else convert hydrogen by use of a catalyst.

In order to avoid short circuits by drop formation of condensate in the interior of the fuel cell housing, a surface of the innermost layer is modified such that said layer does not permit any substantial drop formation of condensate. This is possible by providing hydrophilicity of the inboard surface. By virtue of enhanced hydrophilicity, a contact angle of a water drop which has been formed by condensation becomes smaller such that a thin water film rather than a water drop is formed, the layer thickness of said water film being so minor that an electrical sparkover is suppressed.

The following advantages are derived by virtue of the solutions according to the invention and of the refinements thereof:
the fuel cell housing at a reduced dead weight fulfils all requirements set for an operationally safe housing;
the fuel cell housing is space saving;
linking functions, connectors, and interfaces may be integrated in the fuel cell housing;
electrical short circuits are prevented;
any leakage of hydrogen is effectively prevented; and
explosion-proofing may be integrated.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a cross-sectional diagram of a multi-layered portion of a fuel cell housing according to a first embodiment of the invention;

FIG. 2 is a cross-sectional diagram of a multi-layered portion of a fuel cell housing according to a second embodiment of the invention;

FIG. 3 is a cross-sectional diagram of a multi-layered portion of a fuel cell housing according to a third embodiment of the invention;

FIG. 4 is a cross-sectional diagram of a multi-layered portion of a fuel cell housing according to a fourth embodiment of the invention;

FIG. 5 is a cross-sectional diagram of a multi-layered portion of a fuel cell housing according to a fifth embodiment of the invention.

### DETAILED DESCRIPTION OF THE DRAWINGS

The present invention will be visualized in detail by means of exemplary embodiments. Only those regions of interest of the fuel cell housing according to the invention are illustrated herein. For reasons of clarity, all remaining components have been omitted. Same reference signs refer to same layers/components in the figures.

FIG. 1 schematically shows a triple-layered construction of a portion of a fuel cell housing 10. This layered construction thus comprises a minimum number of individual layers. A first outwardly facing layer 1 is configured as an electrically conductive layer which serves for grounding the fuel cells and is thus capable of also implementing a protection against contact and an electromagnetic compatibility shield. The first layer 1 preferably comprises meshes, fibers and/or films/foils from conductive materials, and in particular a copper mesh. The first layer may advantageously comprise connectors and screw connections for fastening the fuel cell housing or for fastening further components, respectively.

A second layer 2, which in FIG. 1 is illustrated as the central layer, is configured for receiving mechanical forces and as a penetration protection, and functions as a reinforcing or supporting layer, respectively, which can receive bracing forces, discharge operational stress or crash-related stress, and which may implement tertiary explosion-proofing. The second layer 2 advantageous comprises conductive materials such as, for example, conductive polymers, carbon fibers, carbon nanotubes, metal fibers, and mixtures thereof.

That portion of the fuel cell housing 10 that is shown in FIG. 1 furthermore comprises a third layer 3 which faces the interior of the housing 10 and which is configured as a layer insulating against high voltage and insulating in relation to hydrogen.

In particular, a surface of the third layer 3 that faces the interior of the housing 10 is modified such that said surface does not permit any substantial formation of drops of condensate, and said surface to this end is in particular provided with hydrophilicity.

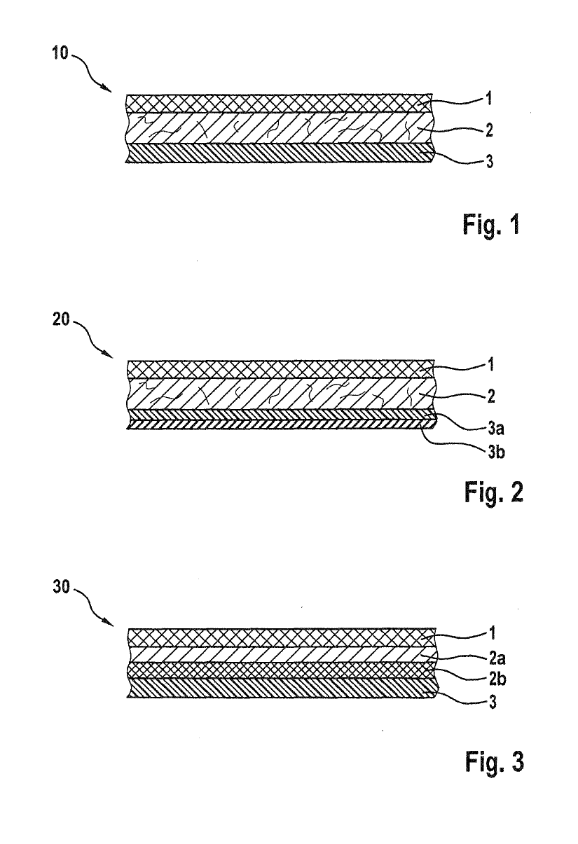

FIG. 2 shows a second design embodiment of the fuel cell housing 20 according to the invention. As opposed to FIG. 1, the third layer is split into two individual layers 3a, 3b. The individual layer 3a herein is configured as a hydrogen-insulation layer and is, in particular, manufactured from a metal layer and/or a polymer layer.

The inwardly facing individual layer 3b is configured as a high-voltage insulation layer and preferably contains non-conductive polymers and/or glass fibers.

FIG. 3 shows a third design embodiment of the invention. The multi-layered portion of the fuel cell housing 30 that is shown in FIG. 3 differs from that of FIG. 1 in that the second layer is split into two individual layers 2a, 2b. The individual layer 2a herein is configured as a penetration-protection layer and contains, in particular, Kevlar or metal. The individual layer 2b is configured as a reinforcement layer for receiving mechanical forces, and comprises, in particular, at least one fibrous material and at least one matrix material. The fibrous material is preferably a carbon-fiber material and is, in particular, available in the form of a semi-finished textile product.

Further layers, such as a layer which absorbs hydrogen or a layer which converts hydrogen, may complement the fuel cell housing structures shown in FIGS. 1 to 3.

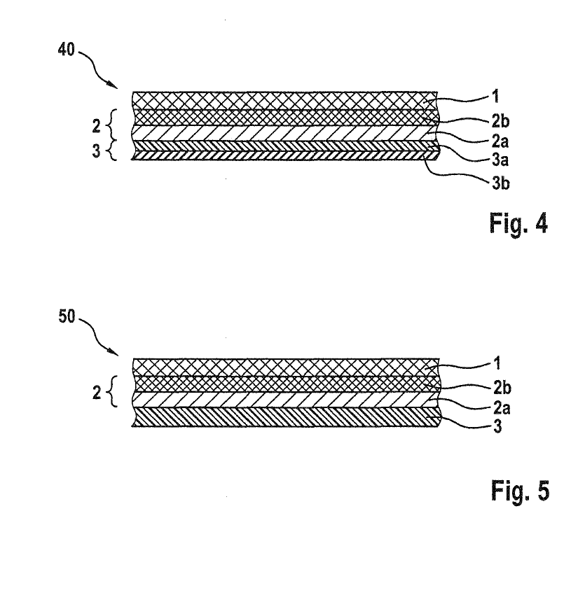

FIGS. 4 and 5 show further preferred design embodiments of a multi-layered portion of the fuel cell housing 40, 50 according to the invention. Here, in each case one first layer 1 is formed by a copper mesh, that is to say by a mesh-type or grip-type copper layer. By virtue of the high conductivity of copper, the first layer 1 is very well suited to grounding the housing. The copper mesh is integrated in a reinforcement layer 2b, which is configured in the form of a plastics material which is reinforced with carbon fiber (CRP). The copper mesh bonds with the resin material of the CRP so as to form an inherent and materially integral connection. This contributes toward stabilizing the reinforcement layer 2b and thus toward reinforcing the housing.

The second layer 2 furthermore comprises a penetration-protection layer 2a which is formed from Kevlar.

According to FIG. 4, a hydrogen-insulation layer 3a which is configured as a polymer layer and which on the exposed side thereof is surrounded by glass fibers as a high-voltage insulation layer 3b adjoins the Kevlar layer. By virtue of the liquid-crystal structure thereof, the glass fibers provide good high-voltage insulation which, depending on the polymer used in the polymer layer, may even be further improved.

FIG. 5 differs from FIG. 4 in the third layer 3. The latter according to FIG. 5 comprises only one polymer layer as the third layer 3, which is configured both as a high-voltage insulation layer as well as to be insulating in relation to hydrogen. The high-voltage insulation may be improved by increasing the layer thickness of the polymer layer.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 First layer
2 Second layer
3 Third layer
2a Penetration-protection layer
2b Reinforcement layer
3a Hydrogen-insulation layer
3b High-voltage insulation layer
10 Fuel cell housing
20 Fuel cell housing
30 Fuel cell housing
40 Fuel cell housing
50 Fuel cell housing

What is claimed is:

1. A fuel cell housing, comprising:
at least one housing portion that has at least three layers, the three layers comprising
a first outwardly facing layer which is configured as an electrically conductive layer, a second layer for receiving mechanical forces and as penetration protection, and a third layer which is configured as a layer which insulates against high-voltage and hydrogen.

2. The fuel cell housing according to claim 1, wherein the first layer comprises meshes, fibers, films and/or foils from conductive materials

3. The fuel cell housing according to claim 1, wherein the first layer comprises a copper mesh.

4. The fuel cell housing according to claim 1, wherein one or more of the first layer and the second layer comprises connectors and/or screw connections for other functions.

5. The fuel cell according to claim 1, wherein the other functions comprise one or more of:
fastening the fuel cell housing, fastening further components, or conducting media.

6. The fuel cell housing according to claim 1, wherein the second layer is formed from at least two individual layers, a reinforcement layer for receiving mechanical forces, and a penetration-protection layer for providing penetration protection.

7. The fuel cell housing according to claim 6, wherein:
the reinforcement layer is a fiber-composite material comprising at least one fibrous material and at least one matrix material,
the fibrous material is a carbon-fiber material, and/or
the fibrous material is present as a semi-finished textile product.

8. The fuel cell housing according to claim 6, wherein the penetration-protection layer is formed from Kevlar or metal.

9. The fuel cell housing according to claim 1, wherein the third layer is formed from at least two individual layers, a high-voltage insulation layer and a hydrogen-insulation layer.

10. The fuel cell housing according to claim 9, wherein the hydrogen-insulation layer is formed by a metal layer and/or a polymer layer.

11. The fuel cell housing according to claim 10, wherein the high-voltage insulation layer contains non-conducting polymers and/or glass fibers.

12. The fuel cell housing according to claim 9, wherein the high-voltage insulation layer is a layer which faces the interior of the housing.

13. The fuel cell housing according to claim 6, wherein the third layer is formed from at least two individual layers, a high-voltage insulation layer and a hydrogen-insulation layer.

14. The fuel cell housing according to claim 13, wherein the hydrogen-insulation layer is formed by a metal layer and/or a polymer layer.

15. The fuel cell housing according to claim 14, wherein the high-voltage insulation layer contains non-conducting polymers and/or glass fibers.

16. The fuel cell housing according to claim 13, wherein the high-voltage insulation layer is a layer which faces the interior of the housing.

17. The fuel cell housing according to claim 1, wherein:
the second layer contains conductive materials,
the fuel cell housing comprises at least one further layer which absorbs hydrogen or converts hydrogen, and/or
a surface of an innermost layer is modified such that said layer does not permit any substantial drop formation of condensate.

18. The fuel cell housing according to claim 17, wherein the conductive materials comprise one or more of conductive polymers, carbon fibers, carbon nanotubes, metal fibers, and mixtures thereof.
